(19) United States
(12) Patent Application Publication
(10) Pub. No.: US 2024/0085120 A1
(43) Pub. Date: Mar. 14, 2024

(54) APPARATUSES AND METHODS FOR EXTRUDING A VISCOUS FOOD PRODUCT

(71) Applicant: The Hillshire Brands Company, Springdale, AR (US)

(72) Inventors: Kent BEARSON, Naperville, IL (US); Kasia JASPER, Batavia, IL (US)

(73) Assignee: The Hillshire Brands Company, Springdale, AR (US)

(21) Appl. No.: 18/465,484

(22) Filed: Sep. 12, 2023

Related U.S. Application Data
(60) Provisional application No. 63/405,730, filed on Sep. 12, 2022.

(51) Int. Cl. F28F 1/00; A23C 19/08; A23P 30/20

(52) U.S. Cl. CPC F28F 1/00; A23C 19/08; A23P 30/20

(57) ABSTRACT

A food product extrusion apparatus includes a heat exchanger. The heat exchanger includes a first portion with a first plurality of tubes and a first cavity located external to the first plurality of tubes. The heat exchange also includes a second portion connected to the first portion. The second portion includes a second plurality of tubes and a second cavity located external to the second plurality of tubes. The first plurality of tubes are offset from the second plurality of tubes.

### CROSS-REFERENCE TO RELATED APPLICATIONS

This application claims priority to U.S. Provisional Patent Application No. 63/405,730 filed Sep. 12, 2022, entitled “APPARATUSES AND METHODS FOR EXTRUDING A VISCOUS FOOD PRODUCT”, the entire contents of which are hereby incorporated by reference.

### FIELD

The present disclosure relates to apparatuses and methods for extruding viscous food products.

### BACKGROUND

This section provides background information related to the present disclosure which is not necessarily prior art.

Food products can be formed using various apparatuses and methods. One type of process is an extrusion process. The ingredients, materials and properties of the food product can affect the ease and efficiency at which a food product can be transported and formed in extrusion processes. Furthermore, extrusion processes can change a temperature of the food product and impart shear, mixing or other forces of the food product.

Existing or traditional extrusion processes suffer from various drawbacks. In some existing systems, the extrusion apparatus is a large piece or assembly of components that can occupy a significant amount of space in a manufacturing or processing facility. Not only does the size of the apparatus translate into significant costs for an operator but it also can make an apparatus unable to fit into some manufacturing environments. Existing apparatuses and processes also may cause a food product to change properties during the process such that the final extruded food item does not have desired characteristics or properties that are preferred by consumers. There exists a need, therefore, for improved extrusion apparatuses and methods that occupy reduced floor space in a manufacturing environment and do not change the properties of the food product during processing. Furthermore, improvements are needed to produce extruded food products that have characteristics that are desirable to consumers.

### SUMMARY

This section provides a general summary of the disclosure, and is not a comprehensive disclosure of its full scope or all of its features.

In some embodiments, a heat exchanger for use in producing extruded food products is provided. The heat exchanger may include a first portion having a first plurality of tubes and a first cavity located external to the first plurality of tubes and a second portion connected to the first portion. The second portion may include a second plurality of tubes and a second cavity located external to the second plurality of tubes. The first plurality of tubes are offset from the second plurality of tubes.

In another aspect, the first plurality of tubes may be circumferentially offset from the second plurality of tubes.

In another aspect, the first plurality of tubes is configured to hold a first volume of food product and the first cavity is configured to position a fluid in thermal communication with the first volume of food product.

In another aspect, the second plurality of tubes is configured to hold a second volume of food product and the second cavity is configured to position the fluid in thermal communication with the second volume of food product.

In another aspect, the first portion is positioned upstream of an extruder.

In another aspect, the heat exchanger may also include an intermediate portion positioned between the first plurality of tubes and the second plurality of tubes to allow mixing of a food product downstream of the first plurality of tubes and upstream of the second plurality of tubes.

In another aspect, the first portion may include a first cylindrical shell that defines an outer wall of the first cavity.

In another aspect, the first plurality of tubes are positioned longitudinally from a first end of the cylindrical shell to a second end of the cylindrical shell.

In another aspect, the second portion may include a second cylindrical shell that defines an outer wall of the second cavity and the second cylindrical shell longitudinally may be aligned with the first cylindrical shell.

In another aspect, the first plurality of tubes are fluidly connected to the second plurality of tubes.

In another aspect, each of the first plurality tubes are longitudinally offset from each of the second plurality of tubes.

In another aspect, each of the first plurality of tubes are circumferentially offset from each of the second plurality of tubes.

In another aspect, the first plurality of tubes are evenly spaced circumferentially around a center axis of the first cylindrical shell.

In another aspect, the first plurality of tubes includes four tubes.

In another aspect, the second plurality of tubes includes a same amount of tubes as the first plurality of tubes.

In other embodiments in accordance with the present disclosure an apparatus for producing portions of a food product is provided. The apparatus may include a pump configured to accept a quantity of food product and a heat exchanger connected downstream of the pump and configured to change a temperature of the food product from a first temperature to a second temperature, wherein the first temperature is different from the second temperature. The apparatus may also include an extruder connected downstream of the heat exchanger and configured to form the food product into a predetermined profile.

In one aspect, the heat exchanger is configured as a counterflow heat exchanger in which a fluid is moved in a direction generally opposite to a movement direction of the food product through the heat exchanger.

In another aspect, the apparatus may also include a portioner positioned downstream of the extruder and configured to separate the extruded food product into portions of predetermined size.

In another aspect, the heat exchanger has an overall length of less than 10 feet.

In another aspect, the second temperature is less than the first temperature.

In another aspect, the second temperature is in the range of about 30° F. to about 35° F.

In another aspect, the extruder may include a cooling jacket configured to maintain an extrusion die in a predetermined temperature range.

In another aspect, the heat exchanger may include a first portion in fluid communication with a second portion.

In another aspect, the heat exchanger may include a first portion with a first plurality of food product conduits and a second portion a second plurality of food product conduits.

In another aspect, the first portion is offset from the second portion.

In another aspect, the first plurality of food product conduits are offset from the second plurality of food product conduits.

In another aspect, the first plurality of food product conduits are circumferentially offset from the second plurality of food product conduits.

In some embodiments of the present disclosure, a method of extruding a food product may include depositing a food product in a food pump. The processed food product having one or more initial product characteristics. The method may also include moving the food product through a heat exchanger to change a temperature of the food product from a first temperature to a second temperature, wherein the second temperature is different from the first temperature. The method may also include passing the food product through an opening to produce an elongated food having a predetermined cross-sectional shape and portioning the elongated food product into food product portions of a predetermined size, wherein the food product portions maintain the one or more initial product characteristics.

In one aspect, the step of moving the food product through the heat exchanger may include moving the food product from a first plurality of conduits to a second plurality of conduits, the first plurality of conduits offset from the second plurality of conduits.

In another aspect, the first plurality of conduits are circumferentially offset from the second plurality of conduits.

In another aspect, the second temperature is less than the first temperature.

In another aspect, the second temperature is in the range of about 30° F. to about 35° F.

In another aspect, the one or more initial product characteristics may include at least one of color and melting temperature.

In another aspect, the food product is a processed food product.

In another aspect, the food product is cheese or cheese product.

In another aspect, the predetermined cross-sectional shape is rectangular.

In another aspect, the food product portions are slices of a cheese or cheese product.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram illustrating an example extrusion apparatus in accordance with some embodiments of the present disclosure.

FIG. 2 is a side view illustrating another example extrusion apparatus in accordance with some embodiments of the present disclosure.

FIG. 3 is a side view illustrating further aspects of the example extrusion apparatus of FIG. 2.

FIG. 4 is a side view illustrating an example heat exchanger that may be used in the extrusion apparatus of FIG. 2.

FIG. 5 is an isometric view of a portion of the heat exchanger of FIG. 4.

FIG. 6 is a sectional view of the heater exchanger of FIG. 5.

FIG. 7 is an end view of the heat exchanger of FIG. 4.

FIG. 8 is an end view of an example extrusion die that may be used in the extrusion apparatus of FIG. 2.

FIG. 9 is an isometric view of an extrusion apparatus in accordance with some embodiments of the present disclosure.

FIG. 10 is a partial sectional isometric view of another example heat exchanger that may be used in the extrusion apparatus of FIG. 2.

FIG. 11 is a flow chart of an example method of extruding a food product in accordance with some embodiments of the present disclosure.

FIG. 12 is a partial sectional isometric view of another example heat exchanger that may be used in the extrusion apparatus of FIG. 2.

FIG. 13 is a cross-sectional elevational view of the heat exchanger of FIG. 12.

FIG. 14 is a cross-sectional plan view of the heat exchanger of FIG. 12.

Corresponding reference numerals indicate corresponding parts throughout the several views of the drawings.

### DETAILED DESCRIPTION

Example embodiments will now be described more fully with reference to the accompanying drawings.

Example embodiments are provided to fully convey the scope of the present disclosure to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In the present disclosure, reference to a particular numerical value includes at least that particular value, unless the context clearly indicates otherwise. When values are expressed as approximations, by use of the antecedent “approximately” or “about,” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

In accordance with various embodiments of the present disclosure, apparatuses and methods for the extrusion of viscous food products are provided. While various elements, steps, and methods described in the present disclosure may be advantageously applied to many differing food products, the present disclosure is particularly advantageous when applied in the context of viscous food products and/or processed food products. The term viscous food product is used in the present disclosure to describe food products that may have a viscosity greater than about 30,000 centipoise (cP) at 65° F. Some of the apparatuses and methods of the present disclosure may be used to extrude and/or produce food products that may have a viscosity that is much greater than 30,000 cP at 65° F., such as more than 5.7×10¹⁴ cP. The term processed food products is used in the present disclosure to describe food products that are mixed with additional ingredients to change the characteristics of the food product. Examples of processed food products include processed cheese that may be prepared by mixing raw cheese with further ingredients such as salt, water, oils, gums, beans, starches, fats, vegetable proteins, or the like to change a color, texture, meltability or other characteristic of the raw cheese.

In various examples, the processed food product may be a natural or processed cheese, such as American cheese. One such example processed food product is a processed cheese. A processed cheese, for example, can be created by mixing one or more raw natural dairy cheeses with further additives to create a specific flavor profile, texture, melting condition, color and other characteristics. A recipe for such a processed cheese can be specifically tested and produced for use with one or more food products such as for sandwiches, pasta dishes, or other food products. It can be desirable, however, extrude the processed cheese product after it has been produced in order to integrate the food product into an assembly or manufacturing line. Further production processes, such as extruding processes, can unintentionally change the characteristics of the processed food product. Such production process can raise the temperature of the processed food product, introduce shear forces into the processed food product. The product processes can alter the characteristics of the processed food product. For example, the processed cheese can change color, change texture, and change meltability if it is subjected to secondary product processes.

The apparatuses and methods of the present disclosure can be used to extrude processed food products, such as a processed cheese, (e.g., American cheese), while maintaining the desired characteristics of the processed food product. While the apparatuses and methods described below can be used to maintain desired characteristics of American cheese or other processed cheese during an extrusion process, the teachings and principles of the present disclosure can also be used in other processed food product applications. For example, the apparatuses and methods (or elements thereof) may be applied to pumping operations, cutting operations, dispensing operations, forming operations, co-extrusion processes, tri-extrusion processes, and the like.

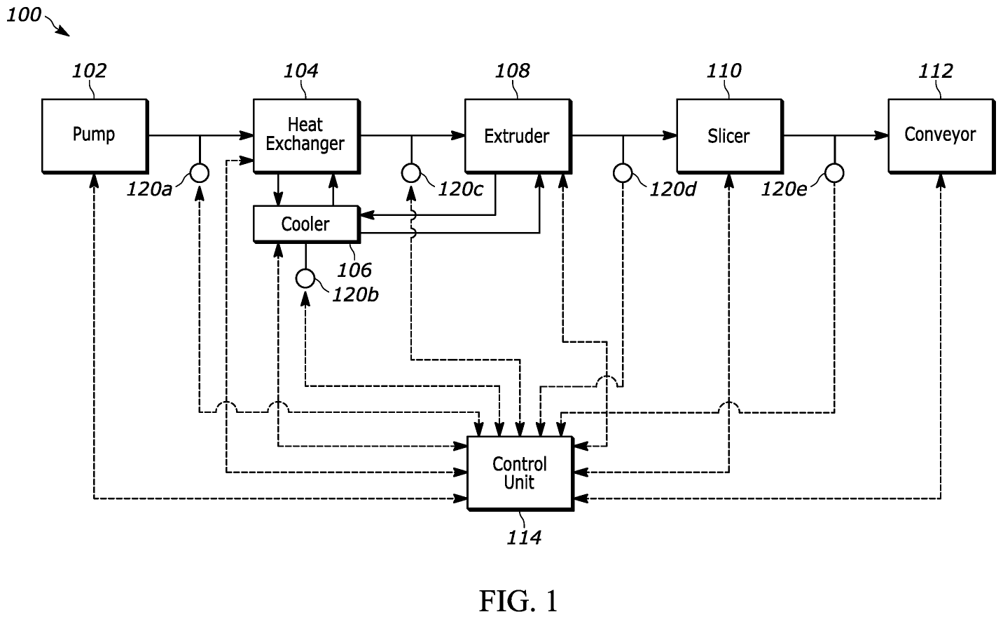

Referring now to FIG. 1, a block diagram of an example extrusion apparatus 100 is shown. The extrusion apparatus 100 may include a pump 102, a heat exchanger 104, an extruder 108, a slicer 110, and a conveyor 112. The elements of the extrusion apparatus 100 may be coupled together using suitable pipes, tubes or other conduits to allow a food product to move from one element to the next. In some examples, the elements of the extrusion apparatus 100 can be coupled directly to one another. In other examples, a stainless steel or other food-grade material can be used to couple the elements together. The extrusion apparatus 100 can be used, for example, to extrude a processed food product, such as American cheese, and deposit slices of the food product onto a food item such as a food tray, food package, sandwich, or the like.

The food product can be input into the pump 102. The pump 102 may include any suitable food-grade pumping apparatus such as a food pump, a screw, auger, or the like. In one example, a positive displacement pump may be used. In one preferred example, a variable pitch screw pump is used. In this example, the pitch is greater at an entrance of the pump 102 and then deceases along the screw toward the exit of the pump. In another example, a fixed pitch screw pump operating in tandem with a lobe pump can be used. As can be seen, the pump 102 may include multiple different types of pumps operating in cooperation to move the food product. In addition to moving the food product through the apparatus 100, the pump 102 may also chop, mix, grind or other perform other processes after the food product is input into the apparatus 100. In one example, the pump 102 is a food-grade vacuum filler. The pump 102 can selected and/or configured depending on the type of the food product (e.g., dairy, meat, etc.).

The food product moves from the pump 102 to the heat exchanger 104. The heat exchanger 104 operates to cool and/or maintain the food product in a predetermined temperature range. The operation of the pump 102 on the food product can increase the temperature of the food product from an initial temperature at which the food product is deposited into the pump to a second temperature that is greater than the initial temperature. Some processed food products can undergo changes to its characteristics if the temperature of the food product is elevated too quickly or is elevated to a temperature above a threshold temperature. The heat exchanger 104 can operate to prevent this undesirable change to the characteristics of the food product. It has been observed, for example, that if the temperature of an American cheese is elevated above about 50° F. that the cheese changes temperature, color, meltability, and/or texture. These changes can make the cheese undesirable to a customer.

The heat exchanger 104, therefore, can operate to maintain the food product at a temperature below about 50° F. In other examples, the heat exchanger 104 can operate to maintain the food product at a temperature below about 40° F. In still other examples, the heat exchanger 104 can operate to maintain the food product at a temperature below about 35° F. In yet other examples, the heat exchanger 104 can operate to maintain the food product in a temperature range from about 30° F. to about 50° F. In yet other examples, the heat exchanger 104 can operate to maintain the food product in a temperature range from about 35° F. to about 54° F. In yet other examples, the heat exchanger 104 can operate to maintain the food product in a temperature range from about 35° F. to about 40° F. In other examples, other temperatures or temperature ranges can be used.

The heat exchanger 104 operates to maintain the temperature of the food product through any suitable heat exchange methodology. For example, the heat exchanger 104 may be a counter-flow heat exchanger whereby a cooling fluid is passed in thermal conductivity with the food product to remove thermal energy (i.e., heat) from the food product to lower the temperature of the food product. In some examples, the cooling fluid is glycol but any suitable food-grade cooling fluid may be used such as water, salt brine, or the like.

The cooler 106 may be coupled to the heat exchanger 104 to move the cooling fluid through the heat exchanger 104 in thermal contact with the food product. The cooler 106 may be a suitable food-grade cooling system that includes a pump and a chiller, for example. One or more conduits can couple the cooler 106 to the heat exchanger 104 to allow the cooling fluid to flow from the cooler through the heat exchanger and back to the cooler 106. The cooler 106 may operate to deliver the cooling fluid to the heat exchanger at a predetermined temperature or at a predetermined temperature differential from the food product. In this manner, the temperature of the food product may be lowered and/or maintained as desired. In some examples, the cooling fluid is provided to the heat exchanger 104 in a temperature range of about 10° F. to about 20° F. In another example, the cooling fluid is provided to the heat exchanger 104 in a temperature range of about 5° F. to about 20° F. In still other examples, the cooling fluid is provided at a temperature differential relative to the temperature of the food product at the input of the heat exchanger (ΔT) of about 20° F. In other examples, other temperature differentials can be used.

The food product may move from the heat exchanger to the extruder 108. The extruder 108 may include an extrusion die through which the food product is moved in order to form the food product into a desired shape. Various food product may have different shapes such as slices, cylinders, nuggets, logs, patties and the like. The die can be sized accordingly to provide the desired shape of the food product. In various examples, the die may extrude the food product into various outer profile shapes such as rectangles, squares, stars, hearts, circles, ovals, etc. In the example of American cheese, the food product may be extruded into an elongated layer that can be sliced into slices at the slicer 110.

The slicer 110 can be any suitable device that can separate the elongated extruded shape that exits the extruder 108 into individual portions as may be desired. In the example of American cheese, the slicer 110 may include a rotating blade and a servo motor that can turn the blade at the exit of the extruder to separate the extruded length of food product into slices of a predetermined size and/or portion. The slices and/or portions may have various predetermined thicknesses as may be required or desired for other food products. In other examples, other portioning devices can also be used such as rotating blades, ultrasonic cutters, mechanical cutters, and the like.

The food product can move from the slicer 110 to the conveyor 112. The conveyor 112 can be any suitable conveyance or motive device that can move the sliced food product to a subsequent process or to a subsequent location. For example, the conveyor 112 may be a conveyor belt, moving tray, moving receptacle, or other conveyance device that moves the sliced food product to another processing station wherein the food product may be further assembled, frozen, cooked, packaged, or the like.

As further shown, the apparatus 100 may also include a control unit 114. The control unit 114 may operate to receive information from various data sources, sensors, or elements of the apparatus 100. The control unit 114 may also perform various operations and/or send instruction or signals to the various elements of the apparatus 100 to cause one or more operating parameters of the apparatus 100 to be changed or to perform a desired operation. For example, multiple sensors 120a, 120b, 120c, 120d, 120e may be positioned at various locations at the inputs or outputs of the elements previously described. The sensors 120 may be temperature sensors such as a thermocouple, thermistor or the like. The sensors 120 may be operable to send or provide a signal to the control unit 114 that indicates a temperature of the food product at the location of the sensor. The sensors 120 may also be or may alternatively provide a temperature of the cooling fluid that is located in the cooler 106 and/or the heat exchanger 104.

The control unit 114 may also be coupled to the pump 102, the heat exchanger 104, the cooler 106, the extruder 108, the slicer 110 and/or the conveyor 112. The control unit 114 may be operable to send instructions to one or more of these elements to change, modify, monitor and/or control the operating parameters of the elements. For example, the control unit 114 may control a flow rate, a pressure, a conveyance speed, a temperature, or other operating parameter. The control unit 114 may be a suitable computing device, workstation, laptop, computer, processing device, controller, programmable logic controller, mobile computing device, tablet, or the like. The control unit 114 may be coupled to the sensors 120 and/or to the elements of the apparatus 100 using any suitable wired or wireless networks.

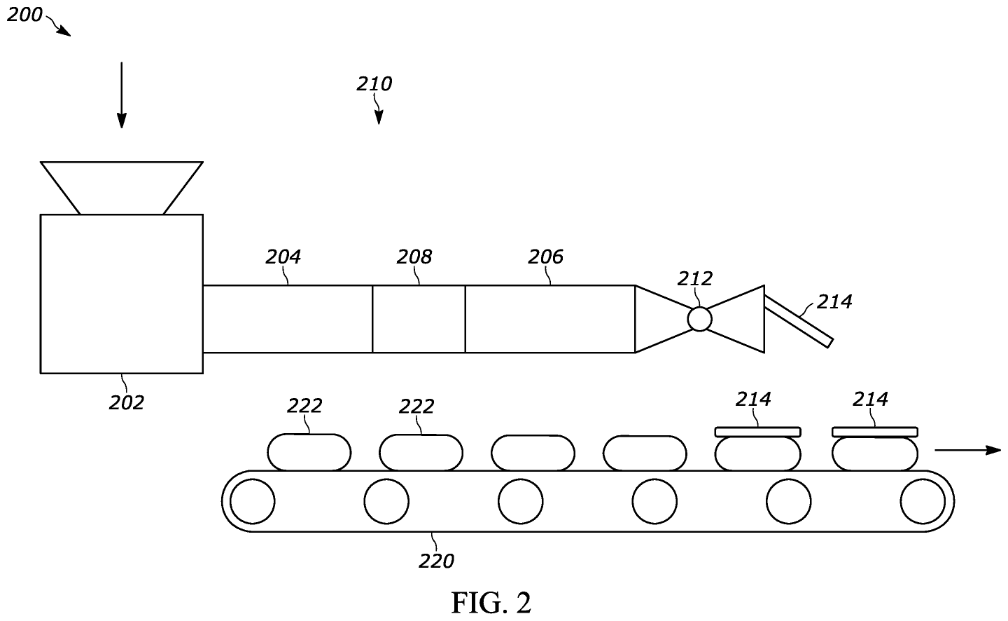

Referring now to FIG. 2, an example extrusion apparatus 200 is shown. The extrusion apparatus 200 may be similar in many respects to the apparatus 100 previously described. In this example, the extrusion apparatus 200 includes a pump 202, a heat exchanger 210, an extruder 212 and a conveyor 220. The pump 2002 may be similar to the pump 102 previously described. The pump 202 may include a hopper or other input receptacle. A viscous or processed food product may be deposited into the hopper. The pump 202 may then feed the food product from the pump 202 to the heat exchanger 210. The pump 202 may be a vacuum filler or other food-grade pump.

The pump 202 may be coupled to the heat exchanger 210 via a suitable pipe or other conduit. The heat exchanger 210 can be similar to the heat exchanger 104 previously described. While not shown, the heat exchanger 210 can be coupled to a cooler or other source of cooling fluid that can flow through the heat exchanger 210 to remove thermal energy from the food product and lower the temperature of the food product to predetermined temperature or may maintain the temperature of the food product in a predetermine temperature range as previously described.

The heat exchanger 210, in this example, includes a first portion 204 and a second portion 206 that are coupled together by an intermediate portion 208. The intermediate portion 208 can be positioned between the first portion 204 and the second portion 206. In this arrangement, the food product may move first through the first portion 204, then through the intermediate portion 208, and then through the second portion 206. Such an arrangement can be advantageous to obtain even or homogenous temperatures in the food product. It has been observed that when the food product has a heterogeneous or excessive temperature gradient across the cross-section of the food product at the extruder 212, that the food product does not evenly extrude and/or undergoes a change to its characteristics. Uneven heating and excessive temperature fluctuation in the food product may result in changes to the color, texture, meltability, taste or other characteristics of the food product.

The food product, when extruded in the apparatus 200, can be cooled in the heat exchanger 210 to not only lower and/or maintain the temperature of the food product in a predetermined temperature range but also to obtain a homogenous temperature profile across the cross-section of the food product. The food product may be cooled in the first portion 204 of the heat exchanger. The first portion 204 of the heat exchanger 210 may be configured as a counter-flow heat exchanger and the food product is moved through one or more tubes that are surrounded by cooling fluid. In such an arrangement, an outer layer (i.e., a layer or portion of the food product in the heat exchanger tube that is closest to the wall of the tube) may undergo more cooling than an inner layer of the food product. Thus, the food product may have an uneven or temperature gradient across the cross-section of the food product.

The food product may be moved through the intermediate portion 208 where the food product may be mixed or combined before it enters the second portion 206. Such combination and then re-introduction of the food product can reduce the temperature gradient and may result in a more homogenous temperature profile of the food product when it is moved into the extruder 212. In one example, as will be further described below, the heat exchange tubes of the first portion 204 may be misaligned or offset from the heat exchange tubes of the second portion 206 to result in a reduction of a temperature gradient of the food product across the cross-section.

The arrangement as shown can result in a consistent and/or homogenous temperature profile of the food product without the need for excessive floor space in a manufacturing environment. As can be appreciated, the food product may also be cooled using a long heat exchanger whereby the food product could be cooled to have a homogeneous temperature profile. In many instances, however, the amount of space available in a manufacturing environment is limited. In the example shown, the heat exchanger 210 may have a length that is less than about ten (10) feet in length. In other examples, the heat exchanger 10 may have a length that is less than about eight (8) feet. In still other examples, the heat exchanger 210 may have a length of about seven (7) feet. In still other examples, other lengths can be used.

After the food product is cooled in the heat exchanger 210, the food product may move into the extruder 212. The extruder 212 may include one or more dies through which the food product is moved to cause the food product to have a predetermined shape such as a cylinder, log, elongated flat shape, or the other shapes. The die, nozzle or other portion of the extruder 212 may also be cooled using a cooling fluid similar to that used in the heat exchanger 210. The nozzle, for example, may have cooling fluid from a cooler, such as cooler 106 or from a separate cooler. The nozzle may be cooled at a location at which a ratio of surface area to mass of the food product is the greatest. While not shown, a portioner or slicer may also be positioned adjacent to or near the outlet of the extruder 212 to separate the elongated extruded food product into a desired portion such as a slice, patty, stick, nugget, or the like.

As further shown, the conveyor 220 may be positioned under the extruder 212 and/or adjacent the extruder 212. The portioned, extruded food product 214 can then be deposited onto the conveyor 220. The conveyor 220 may then move the portioned food product 214 away from the extruder 212 and to a subsequent processing or assembly station as previously described with respect to apparatus 100. In the example shown, the portioned food product 214 may be a slice of American cheese. The sliced cheese product exits the extruder 212 and is deposited onto a sandwich 222 that is located on the conveyor 220. The flow rate of the food product in the apparatus 200 and the portioning of the portioned food product 214 can be coordinated with the speed of the conveyor 220 so that each slice 214 can be deposited on a sandwich 222 in a continuous manner.

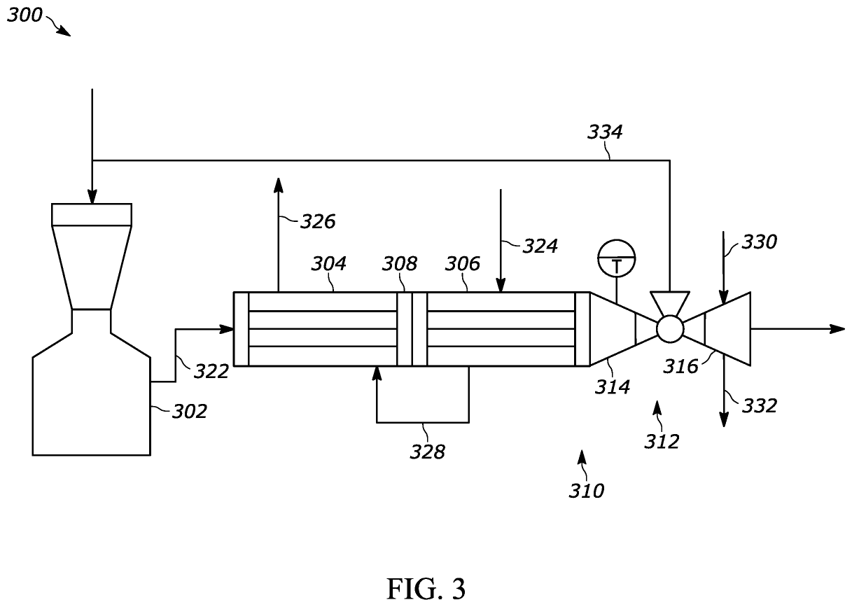

Turning now to FIG. 3, another example extrusion apparatus 300 is shown. The apparatus 300 may be used, for example, to extrude a processed food product such as American cheese. The extrusion apparatus 300 may be similar to the extrusion apparatus 200 previously described. The extrusion apparatus 300 includes a pump 302, a heat exchanger 310 and an extruder 312. The pump 302 may be similar to the pump 102 and/or the pump 202 previously described. The pump 302 may be coupled to the heat exchanger 310 by an inlet line 322 that may be a suitable pipe, tube or other conduit to allow the food product to flow from the pump 302 to the heat exchanger 310. The heat exchanger 310 can be configured as previously described with respect to heat exchanger 210. As shown, the heat exchanger 310 may include a first portion 304, a second portion 306 and an intermediate portion 308 positioned therebetween.

The heat exchanger 310 may be coupled to the extruder 312. The extruder 312 may include a reducer 314 that may reduce the size of the conduit through which the food product moves from an outer size of the heat exchanger 310 to a size of the extruder 312. The extruder 312 may also include an extruder nozzle 316. The extruder nozzle 316 may include a die and/or opening through which the food product is extruded according to a desired profile.

The processed food product (e.g., American cheese) may be introduced or deposited into the pump 302 at an initial temperature. The initial temperature of the food product may be in any suitable range that may be selected for a particular property of the food product or to inhibit contamination of the food product. In one example, the food product is introduced to the pump at a refrigerated temperature. The food product may be introduced, for example, in a temperature range of about 35° F. to about 50° F. In other examples, other temperature ranges or temperature thresholds may be used. The food product is moved using an auger or screw in some examples. This motion may increase the temperature of the food product when the food product exits the pump 302 at the inlet line 322. The temperature of the food product may increase by about 5° F. to about 10° F. as a result of the operation of the pump 302. In some examples, the food product may exit the pump 302 at a temperature in the range of about 42° F. to about 57° F.

As discussed above, it is desirable to maintain the temperature of the food product at a temperature below a predetermined threshold or within a predetermined temperature range. The food product may then be cooled in the heat exchanger 310 to lower the temperature from the elevated temperature at the exit of the pump 302. As further discussed, it may be desirable to maintain a consistent or homogeneous temperature gradient across the cross-section of the food product when it reaches the extruder 312. Thus, the heat exchanger 310 may include two sections (i.e., first portion 304 and second portion 306) that include an intermediate portion 308 that improve the consistency of the temperature of the food product.

As further shown, the heat exchanger 310 may include a cooling fluid inlet 324, a cooling fluid transfer line 328, and a cooling fluid outlet 326. Cooling fluid may flow from a cooler (not shown) into the heat exchanger through the cooling fluid inlet 324. The cooling fluid may remove thermal energy from the food product in the second portion 306. The cooling fluid may then flow from the second portion 306 to the first portion 304 through the cooling fluid transfer line 328. The cooling fluid may then remove thermal energy from the food product in the first portion 304 before flowing out of the first portion 304. As can be seen, the cooling fluid may flow in an opposite direction from the flow of the food product.

The cooling fluid may be any suitable food-grade fluid such as glycol, propylene glycol, water, salt brine or the like. The cooling fluid can be chilled and moved through the cooling loop through the heat exchanger 310 at any suitable temperature to lower the temperature of the food product as desired. In some examples, the cooling fluid is introduced to the heat exchanger at an introduction temperature in the range of about 10° F. to about 35° F. In other examples, the cooling fluid is introduced to the heat exchanger at an introduction temperature in the range of about 10° F. to about 20° F. It may be desirable to minimize the temperature difference between the cooling fluid and the food product so as to reduce the likelihood that the cooling process changes one or more characteristics of the food product. In addition, it is desirable to minimize the likelihood that the food product freezes while it is moving through the extrusion apparatus 300.

As further shown, the extruder 312 may include a cooling fluid inflow 330 and a cooling fluid outflow 332. The same cooling fluid as that previously described that is used in the heat exchanger 310 may also be routed through the extruder 312 to maintain the temperature of the food product in the predetermined temperature range. In other examples, the extruder 312 may be coupled to separate cooler and/or to a separate source of cooling fluid.

As further shown in FIG. 3, the apparatus 300 may include a recirculation line 334. The recirculation line 334 may be a pipe, tube or other conduit that connects the extruder 312 to the pump 302. The recirculation line 334 may allow the food product to routed back to an upstream location in the apparatus 300. The recirculation line 334 may be used, for example, to allow the food product to continue to move in one or more elements of the apparatus 300. If there is a failure or for some other reason the flow of food product in the heat exchanger 310 and/or in the extruder 312 needs to be interrupted, the cooling of the heat exchanger 314 or in the extruder 312 may cause the food product to freeze. If the food product freezes, it can be difficult to re-initiate the flow of the food product. To prevent such a blockage, the food product can be re-routed through the recirculation line 334 to an upstream location (e.g., to the pump 302, to the inlet line 322, and/or to the input of the heat exchanger 310). This may allow the food product to continue to move through the pump 302, the inlet line 322, the heat exchanger 310 and/or the extruder 312 to prevent freezing from occurring. The recirculation line 334 can be coupled to the extruder 312 (or other location) by a suitable valve. Such a valve can be opened automatically when a stoppage, failure or freezing condition may be detected by one or more sensors of the apparatus 300. In other instances, the valve can be opened when maintenance and/or repair is required.

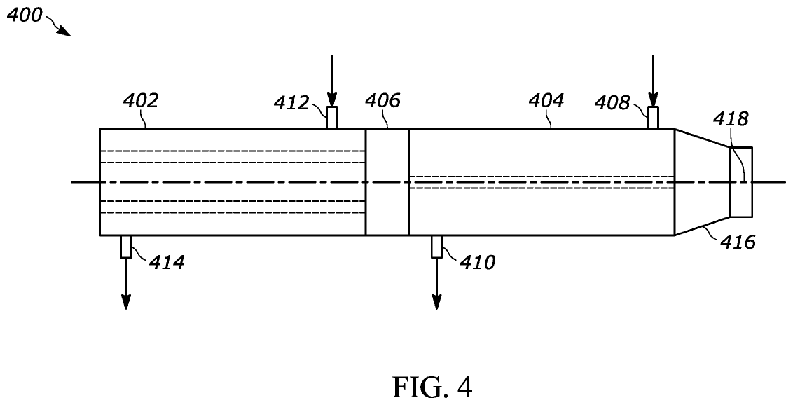

Referring now to FIG. 4, another example heat exchanger 400 is shown. The heat exchanger 400 may be used in the apparatuses 100, 200 or 300. The heat exchanger 400, in this example, is configured similarly to the heat exchangers 210, 310 previously described. As shown, the heat exchanger 400 may include a first portion 402, a second portion 404 and an intermediate portion 406. Each of the first portion 402 and the second portion 404 can be constructed similarly to one another and then joined together. The first portion 402 and the second portion 404 can be joined such that the tubes in the first portion 402 are circumferentially offset from the tubes in the second portion 404. Such an offset configuration is shown in FIG. 4. The tubes in each of the first portion 402 and in the second portion 404 can be provided in various quantities. In various examples, the first portion 402 and/or the second portion 404 may have 2 tubes, 3 tubes, 4 tubes, 5 tubes, 6 tubes, 7 tubes, 8 tubes, or more than 8 tubes. In still further examples, the number of tubes in each of the first portion 402 and in the second portion 404 can be the same or different. The size (e.g., diameter or other cross-sectional dimension) of the tubes in each of the first portion 402 and in the second portion 404 may be the same or different.

The first portion 402 may include an inlet 412 and outlet 414. The second portion 404 may include an inlet 408 and an outlet 410. The inlets 408, 412 may allow the cooling fluid to flow into the heat exchanger and the outlets 410, 414 may allow the cooling fluid to flow out of the heat exchanger. The food product can be moved through one or more chambers or tubes inside the outer shell of the first portion 402 and/or the second portion 404 in thermal contact with the cooling fluid to remove thermal energy from the food product and cool the food product.

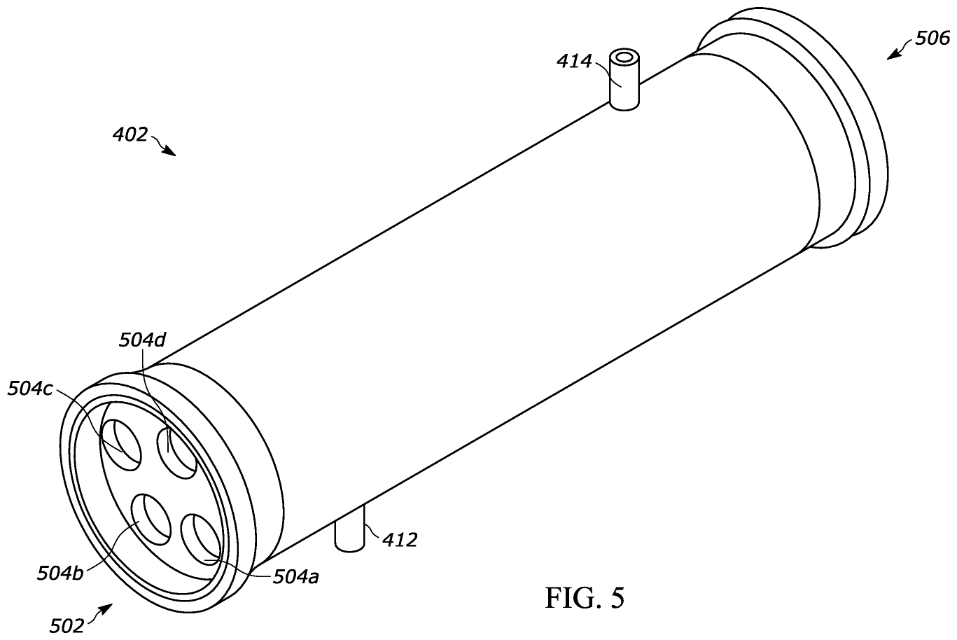

FIGS. 5, 6 and 7 show further details of an example first portion 402 of the heat exchanger 400. As previously stated, the first portion 402 and the second portion 404 can be similarly structured and joined end to end. For the sake of brevity, only the first portion 402 is shown and described but it should be appreciated that the second portion 404 can be similarly structured. The first portion 402 and the second portion 404, however, can be circumferentially offset relative to a central axis 418 of the heat exchanger 400. In this manner, mixing can occur at the intermediate portion 406 to cause the food product to be more consistently heated and/or have a more homogenous temperature gradient across the cross-section of the food product when the food product enters the extruder 416.

As shown in FIG. 5, the first portion 402 of the heat exchanger 400 can have multiple individual tubes 504 that extend from a first end 502 to a second end 506. In the example shown, the first portion 402 includes four individual tubes that include a first tube 504a, a second tube 504b, a third tube 504c, and a fourth tube 504d. In other examples, the first portion 402 may have more than four tubes 504 or less than four tubes 504. The tubes 504 can be spaced evenly circumferentially around a center of the first portion 402. In this example, each of the tubes 504 can be circumferentially spaced by 90 degrees from adjacent tubes 504.

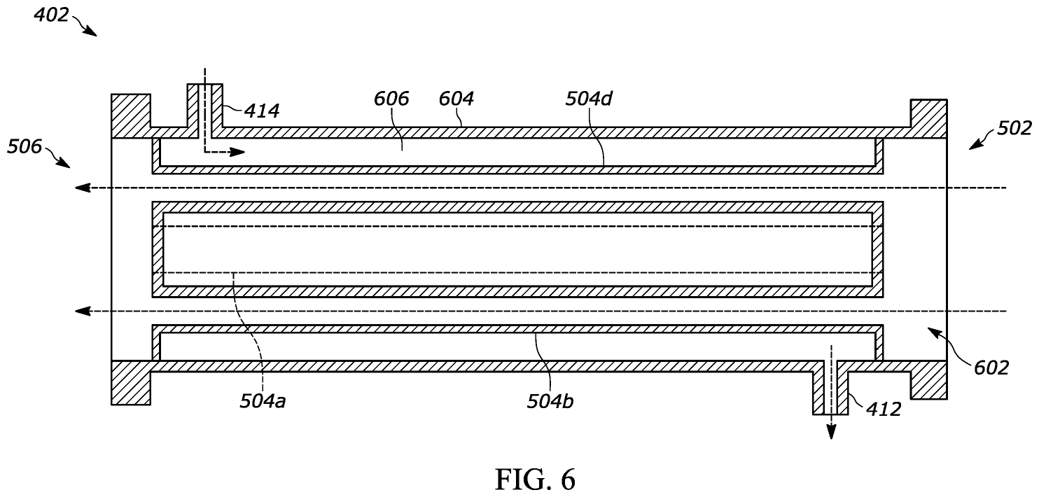

As shown in FIG. 6, the tubes 504 may be inset from the first end 502 and from the second end 506. In this manner, the inset portion defines a cavity 602 at the first end 502 and a similar cavity at the second end 506. When two similarly configured portions are connected together, the cavity 602 may define the intermediate portion 406 (FIG. 4) of the heat exchanger 400. The inset portion may have various longitudinal depths and in one example is about 1 inch in length. Thus, when the first portion 402 and the second portion 404 are connected to each other, the intermediate portion 406 is about 2 inches in length. It may desirable to have other sizes of the inset portion and other sizes of the resulting intermediate portion 406 when the first portion 402 and the second portion 404 are connected together. In an alternate example, the intermediate portion 406 is adjustable. The first portion 402 and the second portion 404 may include complimentary threads or sleeves that can be adjusted to increase or decrease the size of the intermediate portion 406 as may be desired.

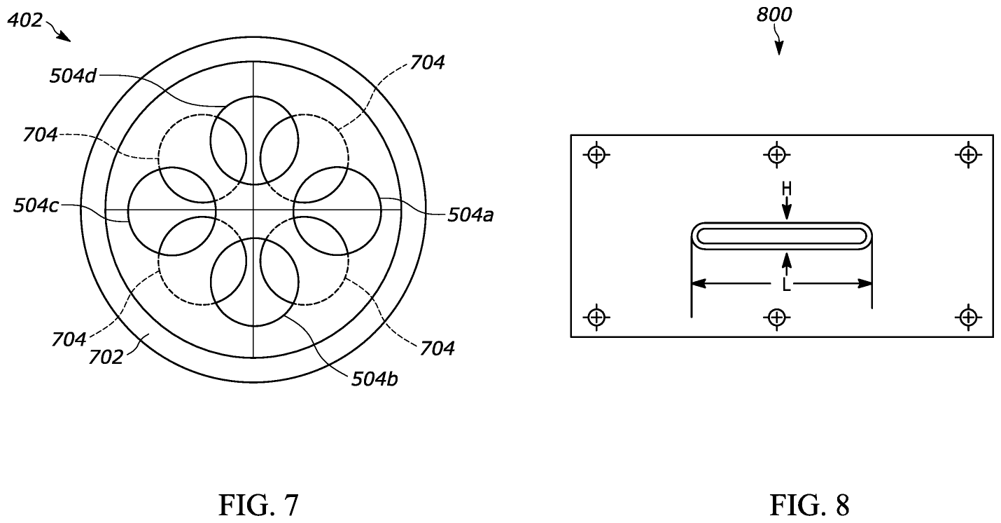

As shown in the end view of FIG. 7, a tube 704 of the second portion 404 can be circumferentially offset from the tubes 504 of the first portion 402 when the two portions are joined together to form the heat exchanger 400. FIG. 7 only shows the relative location of one tube 704 of the second portion 404 but it should be appreciated that the second portion 404 may include four total tubes in a similar manner to the first portion 402. In the example shown, the tubes 704 of the second portion 404 can be circumferentially offset (i.e., the first portion 402 is rotated about a common central axis relative to the second portion 404) from the tubes 504 of the first portion 402 by 45 degrees. In other examples, the two portions can be offset by other angular amounts.

The offset of the tubes 704 of the second portion 404 from the tubes 504 of the first portion allows the food product to mix or combine in the intermediate portion 406. When the food product then enters the tubes 704 from the intermediate portion 406, the food product may be more evenly cooled in the second portion 404 of the heat exchanger. This flow of food product results in a more homogeneous temperature profile of the food product when the food product enters the extruder.

Referring back to FIG. 6, the first portion 402 includes an outer shell 604 that may define a chamber 606 into which the cooling fluid may enter from inlet 414. The cooling fluid can flow around and occupy the chamber 606. The tubes 504 of the first portion 402 may extend through the chamber 606 and be in thermal communication with the cooling fluid in the chamber 606. The food product in the tubes 504 may thus exchange thermal energy with the cooling fluid to cool the food product. As shown, the cooling fluid may flow from the inlet 414 to the outlet 412 in a direction that is generally opposite to the direction of flow of the food product from the first end 502 to the second end 506.

In various examples, the first portion 402 may include other features and/or other configurations other than that shown in FIGS. 5, 6 and 7. For example, the tubes 504 may be shaped with alternatively shaped cross-sections. The tubes 504 may have oval, elliptical or other cross-sectional shapes. The tubes 504 may also have features that can increase the surface area of thermal contact between the tubes and the cooling fluid. The tubes 504 may, for example, have dimples either concave or convex, on the surfaces. The tubes 504 may also have protrusions, bumps, ridges, fins, or the like that may also influence the exchanger of thermal energy between the food product and the cooling fluid.

In other examples, the tubes 504 may have other shapes, profiles or features that can cause the food product to flow in manner in the tubes 504 that can further improve the homogeneity of the food product as it passes through the heat exchanger. For example, the tubes 504 may including rifling, ribs, grooves, directional vanes or the like that can cause the food product to spin or rotate within each tube 504. The spinning or rotation of the food product in the tube may cause the food product to mix to improve the homogeneity of the food product and reduce a temperature gradient across the cross-section of the tube 504.

The heat exchanger 400, including the first portion 402 and/or the second portion 404, may be made of suitable food-grade material with suitable thermal conductivity characteristics. In one example, the heat exchanger 400 is made of a suitable stainless steel. In other examples, other metals, alloys or composites may be used. The tubes 504, 704 may also include a coating on the inner surfaces (i.e., the surfaces in contact with the food product). The coating may be a friction reducing coating to promote the movement of the food product through the tubes 504, 704. In one example, the coating may be a coating applied using an ionic bonding process that may deposit a thin layer of material on the inner surface of the tubes 504, 704. The coating may have a thickness in the range of about 1 to 10 microns and may have a monolayer or multilayer structure. In one example, the coating is made of a layer of Titanium and Nitrogen. In other examples, other suitable coatings may be used.

The heat exchanger 400 (and other elements of the apparatus 100, 200, 300, 900) may include other finishes that can reduce internal friction. The elements such as conduits, tubes, and/or other surfaces may be polished to reduce friction. In some examples, surfaces are treated by an electropolishing process. In other examples, other polishing processes can be used.

The heat exchanger 400 may have various sizes as may be necessary or required to fit within the space requirements of a manufacturing environment. In one example, the heat exchanger 400 may be about seven feet in length. In such an example, the first portion 402 and the second portion 404 may have the same structure and may each be about three and one half feet in length. The first portion 402 and the second portion 404 may have an outer diameter of six inches and each tube 504, 704 may have an outer diameter of two inches. In other examples, the heat exchanger 400 may have other dimensions, including other outer diameter sizes and other lengths.

Referring now to FIG. 8, an extrusion die 800 is shown. The extrusion die 800 may be positioned at an exit position of the extruder 312. The extrusion die 800, in this example, is configured to produce an elongated rectangular strip of food product that can be portioned into slices as it exits the extruder 312. As shown, the extrusion die 800 includes an opening 802 through which the food product exits the extruder. In this example, the opening 802 has a parabolic shape with rounded edges. It has been observed that sharp edges may result in an undesirable shape of the extruded food product. The opening 802, therefore, includes rounded edges to facilitate a uniform desirable food product strip at the extruder 312. The extrusion die 800 may be used, for example, to produce 0.4 ounce slices of American cheese. In such an example, the opening 802 may have a height H of about 0.09 inches and a length L of about 2.7 inches. The opening 802 may also have a chamfer or other feature at the trailing side of the opening 802 at a location where the food product exits the extrusion die 800. In other examples, the extrusion die 800 may other sizes and shapes as may be desired to produce an extrusion of desired shape and/or profile.

In other examples, an extrusion die may have other sizes of the opening 802 shown in FIG. 8. The opening, for example, may have a height that is greater at the ends than at the middle of the opening. In other examples, the middle portion of the opening may have a height H that is greater than a height H at the ends of the opening. In still other examples, one end of the opening may have a height H that is greater than the other end and/or greater than the middle of the opening. Such differences in the extrusion die 80 may be desired for different sizes of the portioned food product or different types of processed food products, different cheeses, different viscosities, etc.

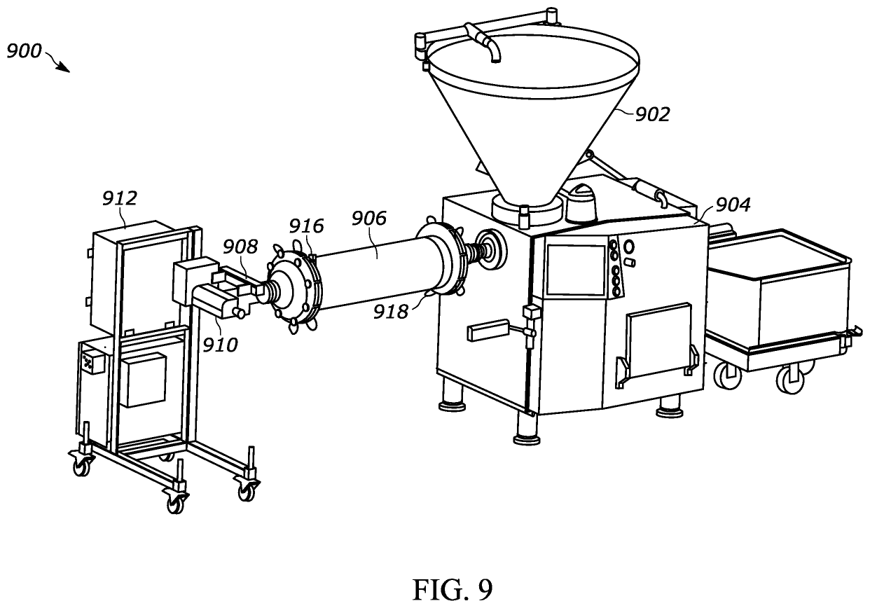

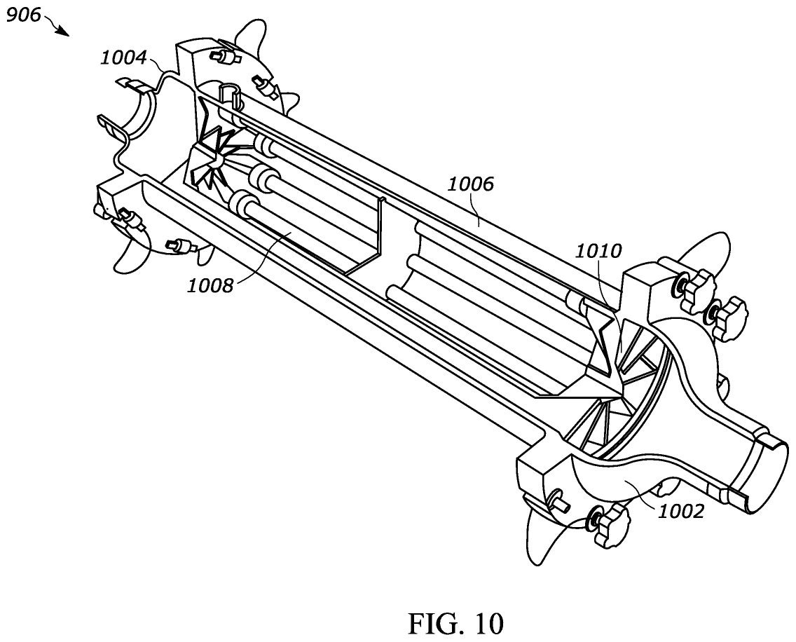

Turning now to FIGS. 9 and 10, another example extrusion apparatus 900 is shown. In this example, the apparatus 900 may include many similar elements to the apparatuses 100, 200 and 300 previously described. The heat exchanger 906, in this example, may have an alternate configuration from that described above. As shown, the apparatus 900 may include a hopper 902, a pump 904, a heat exchanger 906, an extruder 908, a slicer 910 and a control unit 912. For the sake of brevity, the pump 904, the extruder 908, the slicer 910 and the control unit 912 are not described again and may be similar to the elements previously described with respect to apparatus 100, 200 and 300.

The heat exchanger 906, as further shown in FIG. 10, may be different from the heat exchangers previously described. The heat exchanger 906 operates similarly, however, and in a manner to remove heat from the food product in a downstream location of the pump 904. The heat exchanger 906 may be coupled to a cooler and/or a source of cooling fluid (not shown). The cooling fluid may enter the heat exchanger 906 at inlet 916 and exit the heat exchanger 906 at outlet 918. The cooling fluid may be any suitable food-grade cooling fluid such as those previously described.

The heat exchanger 906 may include a plurality of tubes 1008 that extend from a first end 1002 to a second end 1004. The food product may enter the heat exchanger 906 at the first end 1002 and flow through the tubes 1008 to exit the heat exchanger 906 at the second end 1004. The cooling fluid may be positioned in a cavity inside the outer shell 1006 such that the cooling fluid is in thermal contact with the outer surface of the tubes 1008. The heat exchanger 906 may include twelve tubes 1008 that are evenly spaced circumferentially inside the outer shell 1006. In this example, the outer diameter of the outer shell 1006 may be about twelve inches in diameter and each of the tubes 1008 may have an outer diameter of two inches. In other examples, other sizes and dimensions may be used. In certain embodiments, the number of tubes 1008 may be between one and fourteen.

As further shown, the heat exchanger 906 may include a guidance structure 1010 at the first end 1002 and/or at the second end 1004. The guidance structure 1010 may include ramps, rounded edges, angled surfaces or the like that promote the movement of the food product into each of the tubes 1008. In the example shown in FIG. 10, the guidance structure 1010 includes a central conical structure that protrudes in an upstream direction toward the entry position of the food product. The conical structure can promote movement of the food product from a center of the first end 1002 toward the tubes 1008. Angled wedges may also be provided between the openings of each tube 1008 to guide the food product to the openings of each tube 1008. The guidance structure 1010 may improve the flow of the food product into the tubes 1008 and impose less shear forces on the food product. In other examples, the guidance structure 1010 may include other chamfers, rounded features, ramps, inclines, or the like.

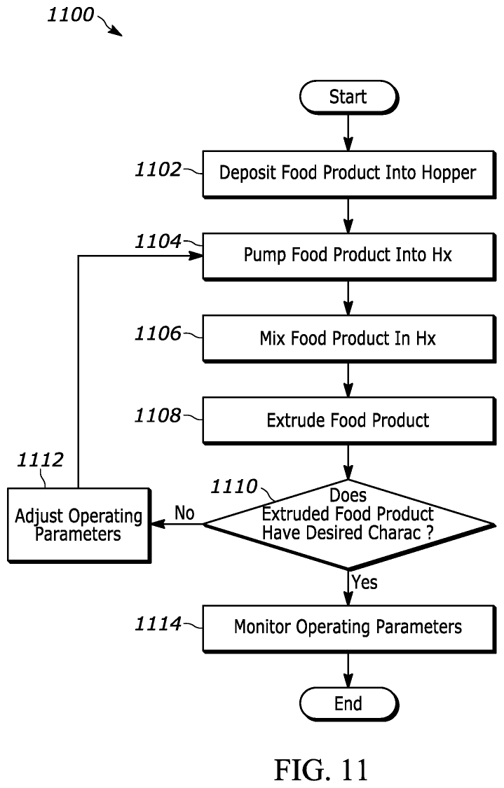

Referring now to FIG. 11, an example method 1100 of extruding a food product is shown. The method 1100 may be performed, for example, using the extrusion apparatuses previously described. While the method 1100 may be performed using any one of the apparatuses 100, 200, 300 or 900 (or other apparatuses), the method 1100 is described with respect to the apparatus 100 for the sake of brevity. It should be appreciated, however, that the method 1100 is not limited to implementation on any particular apparatus.

The method 1100 may begin at step 1102. At step 1102, the food product is deposited into the hopper. The hopper may be included as part of the pump 102. The food product may be deposited manually or using an automated loading process. The food product may include a viscous food product or a processed food product as previously described. The food product may be deposited into the hopper in a refrigerated temperature. The food product, for example, may have a temperature in the range of about 35° F. to about 50° F. In other examples, the food product can be introduced at other temperatures or in other temperature ranges.

At step 1104, the food product may be pumped into a heat exchanger. After being deposited into the hopper, the pump 102 may move the food product using an auger, screw or other pumping device. The pump 102 may move the food product from the pump 102 to the heat exchanger 104. The food product, for example, may move through a suitable tube, pipe or other conduit. As a result of this process, the food product may have an elevated temperature from that at which the food product was first introduced into the hopper at step 1102. The food product may then be cooled in the heat exchanger 104 using a suitable cooling fluid or other cooling process.

At step 1106, the food product is mixed or combined in the heat exchanger. The food product may be mixed or combined in the heat exchanger 104 using any suitable structure or process that results in a homogenous temperature profile across the cross-section of the food product. As previously described, it is desirable to maintain the food product below a predetermined threshold temperature and to have a consistent temperature across the cross-section of the food product. These conditions reduce the likelihood that one or more characteristics of the food product change as a result of the extrusion process. It is desirable, for example, to maintain a taste, color, texture, meltability and other characteristics of the food product.

To improve the temperature profile of the food product, the food product may be mixed in the heat exchanger so that portions of the food product that may be in closer thermal conductivity with the cooling fluid (i.e., portions of the food product in contact with the inner surface(s) of the tube(s) of the heat exchanger) do not excessively vary in temperature from portions of the food product more distant from the thermal conductivity zones. In the example of the heat exchanger 400, the heat exchanger 400 may include the first portion 402, the second portion 404, and the intermediate portion 406. The first portion 402 and the second portion 404 may have longitudinally or circumferentially offset tubes wherein the food product does not flow linearly from the tubes in the first portion 402 to the tubes in the second portion 404. Instead, the food product mixes in the intermediate portion 406 after exiting the first portion 402 and then flows into the offset tubes of the second portion 404. This mixing can result in a more consistent and homogenous temperature profile across the cross-section of the food product at the extruder 108.

In another example, such as in heat exchanger 906. The food product may move from the pump 904 to the first end 1002 (FIG. 10) of the heat exchanger. The food product may mix in the first end 1002 before being routed to the tubes 1008 by the guidance structure 1010. In other examples, the food product may be mixed in the heat exchanger 104 using other structures or configurations.

At step 1108, the food product is extruded. The food product may, for example, be moved through an extrusion die or other opening to produce an extruded food product with a desired profile. The extrusion die may have the structure as shown in FIG. 8, for example. With such a structure, a food product such as American cheese may be extruded and sliced into slices of a predetermined size and shape. In other examples, other extrusion dies may be used.

At step 1110, the food product can be checked to determine if the extruded food product has one or more desired characteristics. The characteristics of the food product may be those characteristics of the food product when the food product was initially introduced in the process. The characteristics may include a taste, color, texture, size, shape, weight, meltability and the like. In some examples, the extruded food product can be tested to determine if the extruded food product exhibits the one or more desired characteristics. In other examples, the characteristics may be automatically determined by the control unit 114 and/or by one or more sensors, measuring devices or the like. If the extruded food product is determined to meet or to exhibit the one or more desired characteristics, the method 1100 moves to step 1114. If the extruded food product is determined not to meet or not to exhibit the one or more desired characteristics, the method 1100 may move to step 1112.

At step 1112, the operating parameters of the extrusion apparatus may be adjusted. The adjustment can be performed automatically by the control unit 114 in some examples. In other examples, the operating parameters can be adjusted by a technician or other operator. The operating parameters can be adjusted using the control unit 114. The operating parameters of the extrusion apparatus 100 may include various parameters that characterize the performance of one or more elements of the apparatus 100. The operating parameters may include an operating pressure of the food product, a flow rate of the food product, a pressure of the cooling fluid, a flow rate of the cooling fluid, a speed or pulse profile of the pump 102, an inlet temperature of the cooling fluid, a temperature differential between the food product and the cooling fluid, a speed or frequency of the slicer 110, and/or an extrusion rate. In other examples, the operating parameters may include other characteristics of the apparatus 100. After the operating parameters are adjusted at step 1112, the method 1100 returns to step 1104 and re-performs steps 1104 through 1110.

At step 1114, the operating parameters of the extrusion apparatus can be monitored. The control unit 114, for example, can monitor the information received from the sensors 120 and the elements of the apparatus 100 to ensure that the apparatus is continuing to perform as desired. The step 1114 can continue until the extrusion method 1100 is complete.

In other methods (not shown), the extrusion apparatus can be set-up using one or more predetermined operating parameters. The operating parameters can be determined, for example, from testing or from historical operating performance data of the apparatus 100. The apparatus can also be operated at different operating levels to produce different quantities of sliced food product or different rates of sliced food product. In one example, the apparatus 100 can be operated to produce sliced American cheese at a rate of 20 slices per minute. In such an example, the cheese being moved through the apparatus can operate at a pressure of 800 pounds per square inch (psi) at the extruder 108. The elements of the apparatus 100 are configured to withstand such high pressure operating conditions (e.g., greater than or equal to about 800 psi). The various connections of the apparatus 100 can include high pressure clamps to withstand this operating pressure as well as other connections such as the connections and/or joints between the pump 102, heat exchanger 104, extruder 108 as well as between the components that may be connected such as the multiple sections of the heat exchanger 104.

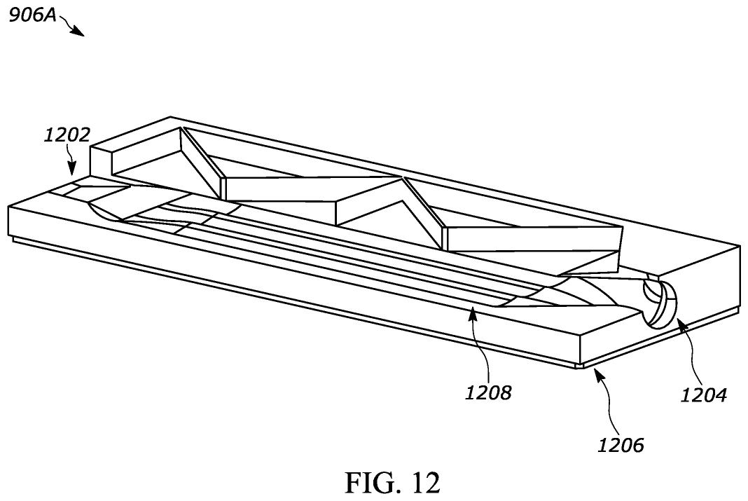

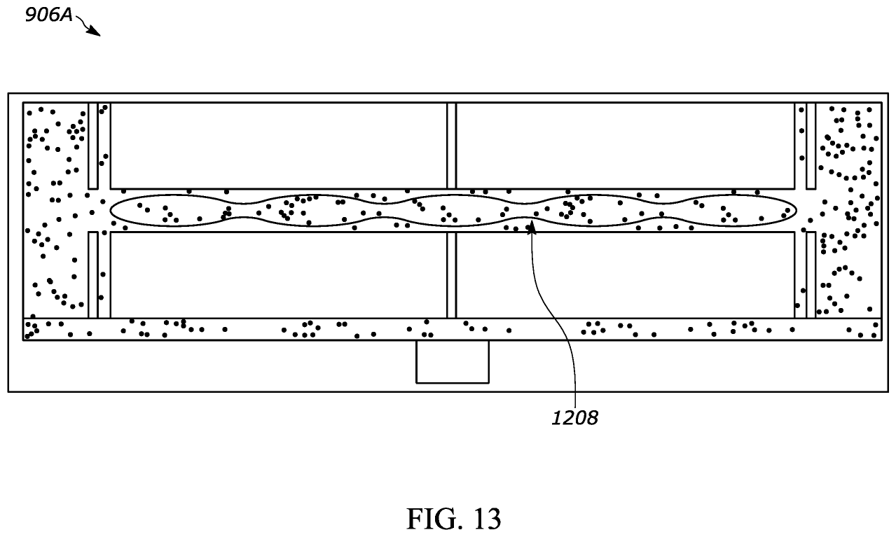

Referring now to FIG. 12, another example heat exchanger 906A is depicted which may be used in the extrusion apparatus of FIG. 2. This exemplary heat exchanger 906A is generally flatter in comparison to the heat exchanger 906 of FIG. 10. Additionally, in an embodiment, the inner tubes 1208 of heat exchanger 906A are connected to form an undulating surface, when viewed in cross-section, on either one major side or on opposite major sides, e.g., as seen in FIG. 13, for the food product to pass through. The food product may enter the heat exchanger 906A at the first end 1202 and flow through the tubes 1208 to exit the heat exchanger 906A at the second end 1204. Either the first end 1202 or the second end 1204 may have one or more input/output ports, respectively connected to the inner tubes 1208. The cooling fluid passes between the outside of the connected inner tubes 1208 and the outer shell 1206 such that the cooling fluid is in thermal contact with the outer surface of the tubes 1208. In an alternative embodiment, the inner tubes 1208 of heat exchanger 906A are connected such that in when viewed in cross-section both major sides are flat (i.e., without undulations). In another alternative embodiment, the inner tubes 1208 are separate and not connected.

FIG. 13 is a cross-sectional elevational view of the heat exchanger 906A of FIG. 12 showing, for one embodiment, the undulations of the inner tubes 1208.

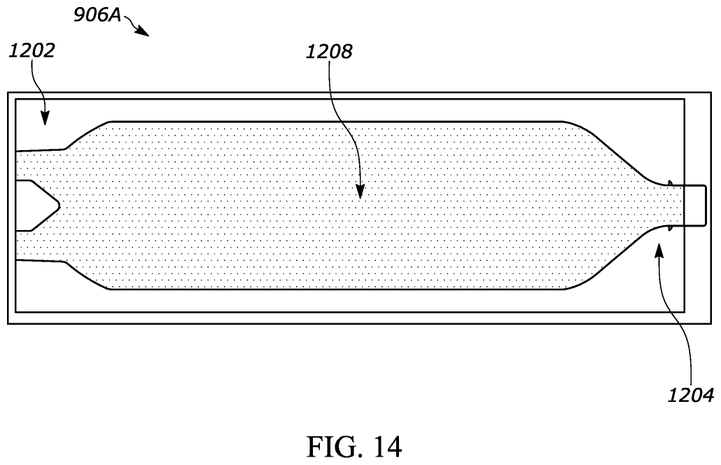

FIG. 14 is a cross-sectional plan view of the heat exchanger 906A of FIG. 12 showing, for an embodiment, connected inner tubes 1208 without undulations, two input ports at first end 1202 and one output port at second end 1204.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

We claim:

1. A heat exchanger for use in a food product extrusion apparatus, the heat exchanger comprising:
a first portion comprising a first plurality of tubes and a first cavity located external to the first plurality of tubes; and
a second portion connected to the first portion, the second portion comprising a second plurality of tubes a second cavity located external to the second plurality of tubes,
wherein the first plurality of tubes are offset from the second plurality of tubes.

2. The heat exchanger of claim 1, wherein the first plurality of tubes are circumferentially offset from the second plurality of tubes.

3. The heat exchanger of claim 1, wherein the first plurality of tubes is configured to hold a first volume of food product and the first cavity is configured to position a fluid in thermal communication with the first volume of food product.

4. The heat exchanger of claim 3, wherein the second plurality of tubes is configured to hold a second volume of food product and the second cavity is configured to position the fluid in thermal communication with the second volume of food product.

5. The heat exchanger of claim 1, wherein the first portion is positioned upstream of an extruder.

6. The heat exchanger of claim 1, further comprising an intermediate portion positioned between the first plurality of tubes and the second plurality of tubes to allow mixing of a food product downstream of the first plurality of tubes and upstream of the second plurality of tubes.

7. The heat exchanger of claim 1, wherein the first portion comprises a first cylindrical shell that defines an outer wall of the first cavity.

8. The heat exchanger of claim 7, wherein the first plurality of tubes are positioned longitudinally from a first end of the cylindrical shell to a second end of the cylindrical shell.

9. The heat exchanger of claim 8, wherein the second portion comprises a second cylindrical shell that defines an outer wall of the second cavity, the second cylindrical shell longitudinally aligned with the first cylindrical shell.

10. The heat exchanger of claim 9, wherein the first plurality of tubes are fluidly connected to the second plurality of tubes.

11. The heat exchanger of claim 10, wherein each of the first plurality tubes are longitudinally offset from each of the second plurality of tubes.

12. The heat exchanger of claim 11, wherein each of the first plurality of tubes are circumferentially offset from each of the second plurality of tubes.

13. The heat exchanger of claim 12, wherein the first plurality of tubes are evenly spaced circumferentially around a center axis of the first cylindrical shell.

14. The heat exchanger of claim 13, wherein the first plurality of tubes comprises four tubes.

15. The heat exchanger of claim 14, wherein the second plurality of tubes comprises a same amount of tubes as the first plurality of tubes.

16. An apparatus for producing portions of a food product comprising:
a pump configured to accept a quantity of food product;
a heat exchanger connected downstream of the pump and configured to change a temperature of the food product from a first temperature to a second temperature, wherein the first temperature is different from the second temperature; and
an extruder connected downstream of the heat exchanger and configured to form the food product into a predetermined profile.

17. The apparatus of claim 16, wherein the heat exchanger is configured as a counterflow heat exchanger in which a fluid is moved in a direction generally opposite to a movement direction of the food product through the heat exchanger.

18. The apparatus of claim 16, further comprising a portioner positioned downstream of the extruder and configured to separate the extruded food product into portions of predetermined size.

19. The apparatus of claim 16, wherein the heat exchanger has an overall length of less than 10 feet.

20. The apparatus of claim 16, wherein the second temperature is less than the first temperature.

21. The apparatus of claim 16, wherein the second temperature is in the range of about 30° F. to about 35° F.

22. The apparatus of claim 16, wherein the extruder comprises a cooling jacket configured to maintain an extrusion die in a predetermined temperature range.

23. The apparatus of claim 16, wherein the heat exchanger comprises a first portion in fluid communication with a second portion.

24. The apparatus of claim 16, wherein the heat exchanger comprises a first portion with a first plurality of food product conduits and a second portion a second plurality of food product conduits.

25. The apparatus of claim 24, wherein the first portion is offset from the second portion.

26. The apparatus of claim 24, wherein the first plurality of food product conduits are offset from the second plurality of food product conduits.

27. The apparatus of claim 24, wherein the first plurality of food product conduits are circumferentially offset from the second plurality of food product conduits.

28. A method of extruding a food product comprising:
depositing a food product in a food pump, the processed food product having one or more initial product characteristics;
moving the food product through a heat exchanger to change a temperature of the food product from a first temperature to a second temperature, wherein the second temperature is different from the first temperature;
passing the food product through an opening to produce an elongated food having a predetermined cross-sectional shape; and
portioning the elongated food product into food product portions of a predetermined size, wherein the food product portions maintain the one or more initial product characteristics.

29. The method of claim 28, wherein the step of moving the food product through the heat exchanger comprises moving the food product from a first plurality of conduits to a second plurality of conduits, the first plurality of conduits offset from the second plurality of conduits.

30. The method of claim 29, wherein the first plurality of conduits are circumferentially offset from the second plurality of conduits.

31. The method of claim 28, wherein the second temperature is less than the first temperature.

32. The method of claim 28, wherein the second temperature is in the range of about 30° F. to about 35° F.

33. The method of claim 28, wherein the one or more initial product characteristics comprise at least one of color and melting temperature.

34. The method of claim 28, wherein the food product is a processed food product.

35. The method of claim 28, wherein the food product is cheese or cheese product.

36. The method of claim 28, wherein the predetermined cross-sectional shape is rectangular.

37. The method of claim 28, wherein the food product portions comprise slices of a cheese or cheese product.
